(19) United States
(12) Patent Application Publication
(10) Pub. No.: US 2003/0226971 A1
(43) Pub. Date: Dec. 11, 2003

(54) Nuclear radiation detector

(76) Inventors: Edwin Arthur Chandross, Murray Hill, NJ (US); Ramaswamy Srinivasa Raghavan, Berkeley Heights, NJ (US)

Correspondence Address: Docket Administrator(Room 3J-219), Lucent Technologies Inc., 101 Crawfords Corner Road, Holmdel, NJ, 07733-3030, US

(21) Appl. No.: 10/167,109

(22) Filed: Jun. 11, 2002

(51) Int. Cl. G01T 1/20

(52) U.S. Cl. 250/361 R

(57) ABSTRACT

An apparatus for detecting energetic radiation from a source. The apparatus includes at least one liquid scintillator for emitting one or more optical signals in response to the energetic radiation. The one or more liquid scintillators comprise a highly metal loaded solution. The apparatus also includes at least one photodetector for detecting the one or more optical signal.

### BACKGROUND OF THE INVENTION

I. Field of the Invention

The present invention relates to a nuclear radiation detector.

II. Description of the Related Art

Radiation detectors have become increasingly prevalent in today's society. Various applications for radiation detectors are known. For examples, see U.S. Pat. No. 4,636,644, U.S. Pat. No. 4,613,756, U.S. Pat. No. 4,799,247, U.S. Pat. No. 5,606,167, U.S. Pat. No. 5,764,683, U.S. Pat. No. 6,216,540, U.S. Pat. No. 6,249,567, U.S. Pat. No. 6,335,957, U.S. Pat. No. 6,359,279, and U.S. Pat. No. Re. 36,201, each hereby incorporated by reference.

Radiation detectors, for example, have been employed in detectors for the nondestructive inspection of objects, including contraband. Here, the object for inspection is bombarded with energetic radiation, such as gamma-, x-ray, and/or neutron radiation, for example. A point source generates the radiation, which penetrates the object. Thereafter, an image may be derived through the use of a radiation detector, which detects and records the radiation transmitted through object. More particularly, the radiation detector converts the energy carried by the penetrating particles, or quanta, into visible light, which is recorded to create a suitable image of the object.

Another application of radiation detectors is in medical diagnostic tools, such as positron emission tomography (“PET”), singular photon planar imaging, and single photon emission computed tomography (“SPECT”), for example. These tools rely on diagnostic nuclear imaging where the location and flow of a positron-emitting radio-pharmaceutical(s), such as ^{99m}Tc or 18 F-fluorodeoxyglucose (FDG), for example, as ingested by a patient under examination, is traced. Positrons emitted by the pharmaceutical combine almost instantaneously with an electron of the surrounding material to produce two quanta of gamma radiation. A radiation detector detects the gamma radiation or gamma rays and the relevant information is recorded for computer analysis. Once recorded, the information may be processed to determine the location of the location of the positron-emitting material and to enable the graphical preparation of an image of an organ or blood vessel, for example, into which the pharmaceutical has passed.

Radiation detectors have been realized using a number of differing technologies. One approach for detecting gamma- and/or x-rays, as well as neutrons and/or neutrinos has included a crystal-based scintillator in conjunction with an array of photodetectors (e.g., photo multipliers). In response to an intended type of incoming radiation, the crystal-based scintillator generates an optical signal(s). The optical signal(s) generated may correspond with the intensity of the incoming radiation. The optical signal(s) is subsequently detected by one or more photomultipliers, which generate an electrical signal for computer analysis and image processing, for example.

Radiation detectors realized by crystal-based scintillators have a number of limitations. Crystal-based scintillators may be best suited for low flux-type applications. Thusly, crystal-based scintillators may not be sufficiently energy sensitive to detect high-speed particles, such as neutrons, given practical size constraints for certain applications. Moreover, crystal-based scintillators may be costly and are not easily reconfigurable. For a number of radiation detector-type applications, greater flexibility, however, may be increasingly necessary. Consequently, a need exists for a radiation detector suited for both low flux and high flux applications that may be less costly and more flexible than crystal-based scintillators.

### SUMMARY OF THE INVENTION

The present invention provides a radiation detector for detecting energetic radiation for various applications, including medical diagnostic tools, contraband detectors, nuclear power plant sensors, and the detection of the transport of fissionable material, for example. More particularly, the radiation detector employs a highly metal loaded liquid scintillator to increase the energy sensitivity, efficiency and flexibility over known crystal-based scintillators. Thusly, the radiation detector of the present invention may be suited for low flux and/or high flux applications. Moreover, the radiation detector of the present invention may be suited for as a large area detector(s) because of the use of a liquid scintillator. Likewise, the radiation detector of the present invention is advantageous because the shape of the vessel or container storing the liquid scintillator may be varied, allowing for greater flexibility such that the radiation detector may be adjusted as desired.

In another embodiment of the present invention, the radiation detector comprises one ore more liquid scintillators for emitting an optical signal(s) in response to one or more forms of energetic radiation, such as gamma-rays and/or neutron particles, for exampl4e. The radiation detector further comprises one or more photodetectors for detecting the optical signal(s) emitted by the liquid scintillator(s). The liquid scintillator(s) have an energetic radiation sensitivity of at least 50 keV and a quenching loss of less than about 25%. To achieve these benefits, the liquid scintillator comprises an organic solution having at least 10% metal ions by weight solvated therein.

### BRIEF DESCRIPTION OF THE DRAWINGS

The present invention will be better understood from reading the following description of non-limiting embodiments, with reference to the attached drawings, wherein below:

FIG. 1 depicts a first embodiment of the present invention;

FIG. 2 depicts another embodiment of the present invention;

FIGS. 3(a) and 3(b) depict another embodiment of the present invention;

FIG. 4 depicts another embodiment of the present invention;

FIG. 5 depicts another embodiment of the present invention;

FIG. 6 depicts a first aspect of the experimental results;

FIG. 7 depicts another aspect of the experimental results; and

FIG. 8 depicts another aspect of the experimental results.

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION

The present invention provides a radiation detector for detecting energetic radiation for various applications, including medical diagnostic tools, contraband detectors, nuclear power plant sensors, and the transport of fissionable material, for example. More particularly, the radiation detector employs a highly metal loaded liquid scintillator to increase the energy sensitivity, efficiency and flexibility over known crystal-based scintillators. Thusly, the radiation detector of the present invention may be suited for low flux and/or high flux applications. Moreover, the radiation detector of the present invention may be suited for as a large area detector(s) because of the use of a liquid scintillator. Likewise, the radiation detector of the present invention is advantageous because the shape of the vessel or container storing the liquid scintillator may be varied, allowing for greater flexibility such that the radiation detector may be adjusted as desired.

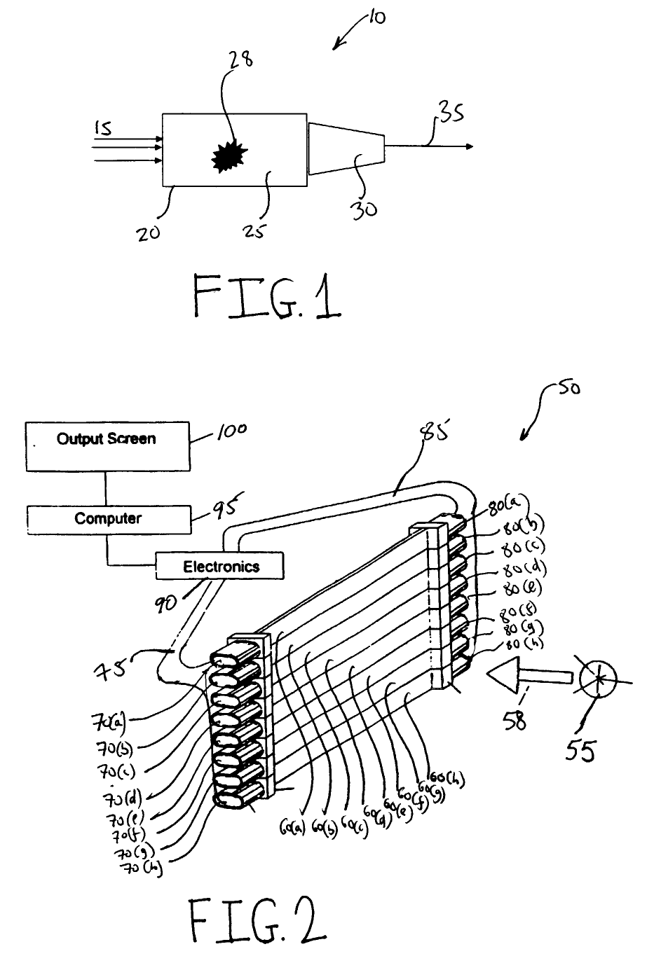

Referring to FIG. 1, a radiation detector 10 is shown in accordance with the principles of the present invention. Radiation detector 10 may detect one or more forms of incoming energetic radiation 15, such as gamma-, x-ray, and/or neutron radiation, for example. To achieve this functionality, radiation detector 10 comprises a liquid scintillator 25 stored or contained within a vessel 20. Liquid scintillator 25 is a highly metal loaded solution. One method of making a highly metal loaded solution is disclosed in co-pending and commonly assigned U.S. patent application Ser. No. ______ , filed on May 31, 2002, hereby incorporated by reference. A highly metal loaded solution may comprise an organic solution having at least 10% metal ions by weight solvated therein. The metal ions may comprise Ce, Pr, Nd, Pm, Sm, Eu, Th, Dy, Ho, Er, Tm, Lu, In, Gd, Pb and/or Yb, the selection of which depends on the type(s) of energetic radiation to be detected.

Operationally, incoming energetic radiation 15 interacts with the highly metal loaded solution of liquid scintillator 25. As a consequence, scintillation light 28 is emitted from liquid scintillator 25. The power level of scintillation light 28 may vary with the intensity of the incoming energetic radiation. In one example of the present embodiment, scintillation light 28 has a wavelength of about 430 nm. It will be apparent to skilled artisans from the instant disclosure, however, that various different schemes may also be alternatively realized.

A photodetector 30 is coupled with liquid scintillator 25 for receiving the emitted scintillation light 28. Photodetector 30 generates an electrical signal 35 corresponding with the emission of scintillation light. Various schemes may be realized using the photodetector 30. For example, a characteristic, such as amplitude, periodicity and/or pulse width, of electrical signal 35 may vary with a characteristic, such as the power or wavelength, of the detected scintillation light 28 emitted by liquid scintillator 25.

By employing the above configuration generally, and the highly metal loaded liquid scintillator, several advantages may be realized. Firstly, radiation detector 10 may have an energetic radiation sensitivity of as low as 50 keV. Moreover, quenching loss within liquid scintillator 25 may be less than about 25%.

It should be noted that vessel 25 should have corrosion resistant properties. Consequently, vessel 25 may be realized by stainless steel, glass, fluoro-polymers such as Teflon® and substitutes therefor, for example. Other properties will be apparent to skilled artisans, depending on the application of radiation detector 10.

Referring to FIG. 2, a radiation detector array 50 is illustrated in accordance with another embodiment of the present invention. Radiation detector array 50 is designed to detect one or more forms of incoming energetic radiation 58, such as gamma-, x-ray, and/or neutron radiation, for example. Radiation detector array 50 realizes this functionality by employing an array of distinct liquid scintillators, each contained in individual, anti-corrosive vessels, 60(a) through 60(h). Each liquid scintillator may comprise a different metal for the highly metal loaded solution to suppose detection of a different form of incoming energetic radiation. For example, liquid scintillators 60(a) and 60(b) may respectively comprise B and Gd to detect slow neutrons, liquid scintillator 60(c) may comprise Yb to detect fast neutrons, liquid scintillator 60(d) may comprise In to detect very fast neutrons, while liquid scintillators 60(e) and 60(f) may respectively comprise Pb and Yb to gamma-rays.

As detailed hereinabove, the highly metal loaded solution of each liquid scintillator within vessels, 60(a) through 60(h), emits scintillation light. The scintillation light is emitted in response to receipt of energetic radiation 58 from a source 55. The emission of scintillation light, however, depends on the design (e.g., metal loaded) of each specific liquid scintillator. It should be noted that source 55 might be a remote nuclear power plant or facility, fissionable material/contraband, nuclear weapons, and/or radiopharmaceuticals, for example.

Coupled with each vessel, 60(a) through 60(h), is a photodetector of an array, 70(a) through 70(h). A second array of photodetectors, 80(a) through 80(h), may also be employed in a likewise manner depending on the geometries, sensitivities and response time desired for radiation detector 50. Each photodetector of the first and/or second arrays, generates an electrical signal in response to detecting scintillation light. Each photodetector may be tuned by wavelength, for example, to avoid false triggers from an adjacent liquid scintillator(s).

Radiation detector 50 may also comprises electronics 90 for processing the electrical signals generated by photodetector, 70(a) through 70(h) and/or, 80(a) through 80(h). Electronics 90 may incorporate filters to reduce the noise and increase the signal to noise ratio, for example. Moreover, electronics 90 also may convert each received electrical signal to digital signals or a stream. Once processed by electronics 90, radiation detector 50 feeds the digital signals or stream to a computer 95. Computer 95 may then analyze the digital signals or stream to determine particular characteristics source 55, such as its relative location, for example. The resultant analysis may then be provided to a user by means of an output display screen 100, such as a computer monitor or printer, for example.

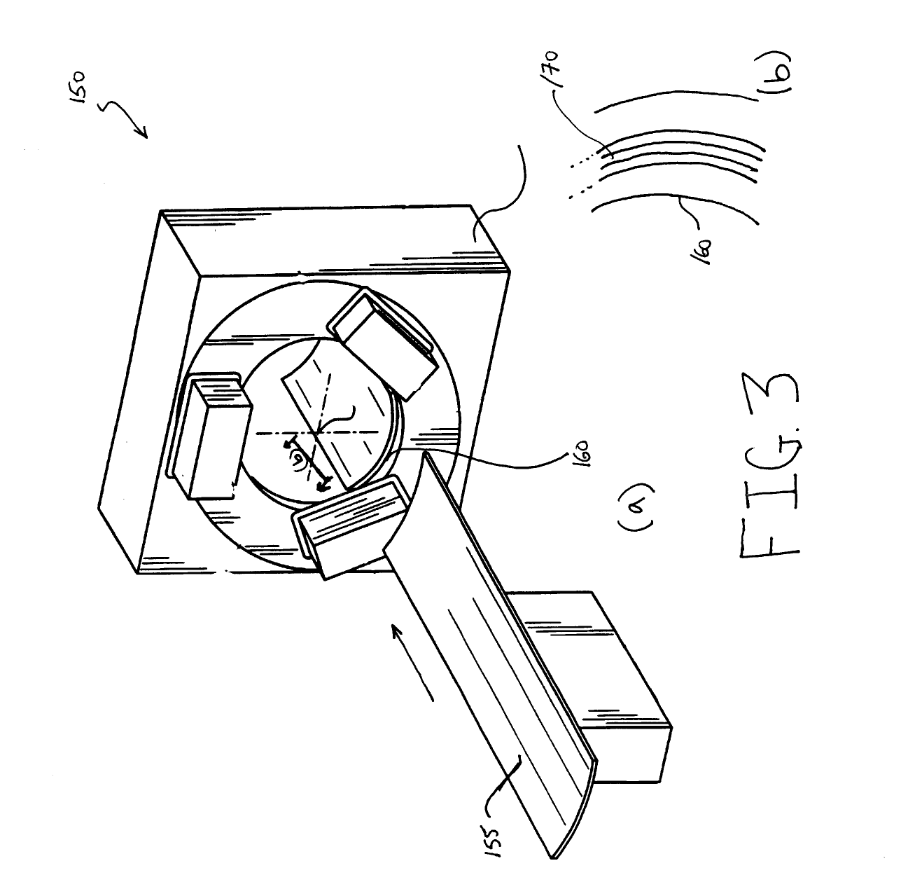

Referring to FIGS. 3(a) and 3(b), a gamma-ray detector 150 is illustrated in accordance with another embodiment of the present invention. Gamma-ray detector 150 may be part of a medical diagnostic tool, such as tomography, PET or SPECT, for example. Gamma-ray detector 150 comprises a cantilevered bed 155 in which the patient lies down upon. The patient ingests a radiopharmaceutical having a relative short half-life and emitting gamma rays. Various radiopharmaceuticals are known to skilled artisans for such applications. Sometime after ingestion, cantilevered bed 155 moves into gamma-ray detector 150. More particularly, the area(s) of interest for medical diagnosis is positioned within gamma-ray detector 150.

Gamma-ray detector 150 comprises one or more liquid scintillators 170 stored or contained within a vessel 160. Vessel 160, and therefore, liquid scintillator 170 encircles and/or surrounds the patient and cantilevered bed 155. From the gamma rays emitted by the patient from the ingested radiopharmaceutical and with the assistance of computer-analysis and processing, gamma-ray detector 150 may create at least a two-dimensional image of the area(s) of interest.

As detailed hereinabove, liquid scintillator 170 is a highly metal loaded solution. For example, liquid scintillator 170 may comprise may comprise an organic solution having at least 10% metal ions by weight solvated therein. The metal ions may comprise Pb and/or Yb, depending on the efficiency desired. The efficiency of gamma-ray detector 150 corresponds, to some degree, on the atomic number of the metal employed. More particularly, a higher atomic number for a useful metal for liquid scintillation from gamma-rays will produce a more efficient detector.

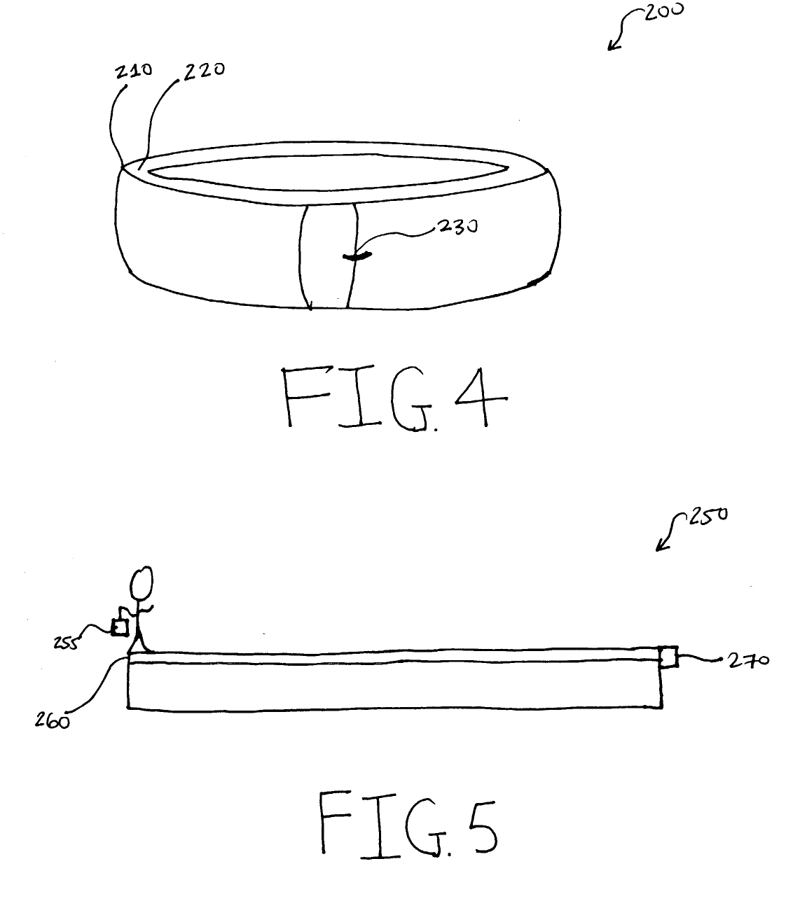

Referring to FIG. 4, a flexible radiation detector 200 is illustrated in accordance with another embodiment of the present invention. Flexible radiation detector 200 may be used for detecting gamma-rays and/or neutron particles. Flexible radiation detector 200 comprises a flexible material 210 having a flexible vessel 220 for storing and containing one or more liquid scintillator(s). Flexible material 210 is adjustable to fit around a source (not shown) of energetic radiation. Flexible material 210 may also comprise a zipper, button, clip, Velcro® strip or other attachment means 230, for encompassing and/or wrapping the source with flexible vessel 220. One or more photodetectors (not shown) are positioned within flexible material 210 to detect the energetic radiation emitted by the source. With the assistance of computer-analysis and processing, flexible radiation detector 200 may assist in the formation of at least a two-dimensional image of the source of energetic radiation.

Flexible radiation detector 200 may be designed as a medical diagnosis tool, much like that disclosed hereinabove in conjunction with FIGS. 3(a) and 3(b). While perhaps less robust than gamma-ray detector 150, flexible radiation detector 200 can be more adaptable to the source (e.g., patient) as well as more localized to the area of interest.

Alternatively, flexible radiation detector 200 may also be employed to detect concealed contraband. Here, small or trace amounts of radioactive and/or fissionable material may be concealed on the source; e.g., in the body or on the person. Because of its localized advantages, flexible radiation detector 200 may be employed to home in on the specific area emitting gamma-ray radiation. In this manner, flexible radiation detector 200 may be alternatively shaped as a hand-held wand, for example.

If flexible radiation detector 200 is intended to detect radioactive material, it will be effectively a gamma-ray detector. In this manner, liquid scintillator 220 is formed from an organic solution having at least 10% metal ions by weight solvated therein, where the metal ions may comprise Pb and/or Yb. On the other hand, if flexible radiation detector 200 is intended to detect fissionable material, it will be effectively a neutron particle detector. To realize this aim, liquid scintillator 220 is formed from an organic solution having at least 10% metal ions by weight solvated therein, where the metal ions may comprise B, Gd, Yb and/or In.

Referring to FIG. 5, a detector 250 for detecting the transport of concealed contraband in the form of radioactive and/or fissionable material is illustrated in accordance with another embodiment of the present invention. Detector 250 may detect gamma-rays and/or neutron particles. Detector 250 may be realized by a walkway in airport, a pathway or a driveway leading to a bridge, tunnel or access point, luggage carousels in air, train and/or shipping terminals, for example, where the transport of concealed contraband may be of interest or concern.

Detector 250 is of sufficient length such that the presence of concealed contraband from a source 255 may be detected by one or more liquid scintillators 260 in conjunction with one or more photodetectors 270. In one example, the length of detector 250 is about 100 m. As detailed hereinabove, detector 250 may employ one or more liquid scintillators loaded with metal ions of corresponding sensitivity to the type of radiation of interest to be detected. Thusly, liquid scintillators 260 may be formed from an organic solution having at least 10% metal ions by weight solvated therein, where the metal ions may comprise Pb and/or Yb such that detector 250 may detect gamma-rays. Similarly, liquid scintillators 260 may be formed from an organic solution having at least 10% metal ions by weight solvated therein, where the metal ions may comprise B, Gd, Yb and/or In to detect neutron particles.

Source 255 is shown as a carrying bag being transported by a human. However, it will be apparent to skilled artisans upon reviewing the instant disclosure that the concealed source of the contraband may be stored within an automobile or other moving vehicle. To insure detection, detector 250 may be sufficiently inconspicuous such that its presence is not known to the transporter of the concealed contraband.

### Experimental Results

In one series of experiments, a luminous indium-loaded liquid scintillator (“LS”) was examined with respect to proton-proton (pp) solar neutrinos (vₑ) by tagged vₑ capture in ¹¹⁵In. Intense background from the natural β-decay of In was observed to be reduced by about 100× using the In-LS of the experiment. Eight tons of In with only ppt U/Th located in a moderately deep underground site was observed to yield ˜400 pp vₑ/y after analysis cuts. With a threshold of Q=118 keV, In was observed to be the most sensitive detector of the pp vₑ spectrum.

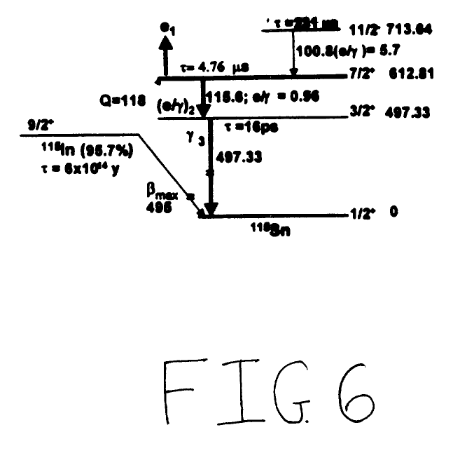

One known approach for observing solar vₑ detection—a taggable vₑ capture—was proposed with indium as the specific target. vₑ-Capture in ¹¹⁵In leads to an isomeric state (τ=4.7 μs) in ¹¹⁵Sn, releasing a prompt electron—the vₑ signal. Its energy may directly measure the vₑ energy: Eᵥ=Eₑ+Q. The low vₑ thresh-old Q=118 keV may reach most of the pp vₑ spectrum (0-420 keV). The signal electron can be tagged as the product of vₑ capture by a unique delayed space-time coincidence of radiations (116+497=613 keV) de-exciting the isomeric state, as shown in FIG. 6. With the about 96% abundance of ¹¹⁵In, the theoretical signal is about 365 pp vₑ/yr in an attractively modest 4 ton mass of In^{1, 1}.

A pp vₑ target was identified from stable ¹⁷⁶Yb⁷. This presented no target decay problems. Consequently, Yb became the focus of further experiments. LS spectroscopy may be ideal for massive low energy vₑ detectors if metal bearing targets could be loaded into the LS. A number of experiments were performed in this regard to develop such as a metal-loaded LS.

A detector employing Yb or In, based on metal loaded LS may typically demand prescriptions such as about 10% loading and a scintillation signal strength sufficient for precision spectroscopy at <100 keV in a massive device with long term stability. However, until the present experiments, such a metal LS has not been produced.

The standard method for a metal-LS is solvation of an organic salt of the metal in a luminous organic LS solvent. The procedure involves two basic aspects: (1) defining the lowest mass organic salt complex that can be dissolved in a LS solvent free of aggregation and light scattering and/or quenching; and (2) conversion of an inorganic salt of the metal into the selected organic salt complex and extraction into the LS solvent. While step (2) is standard chemistry, step (1) is less predictable “a priori.”

The components of a metal LS include (1) an organic salt of the metal; (2) a complexing system; (3) the LS solvent; and (4) scintillation fluors. The experimental choices for (3) and (4) of the metal LS, in the experiments, were from traditional LS spectroscopy. However, the selections for (1) and (2) of the metal LS were varied to develop an experimental roadmap. Thus, systematic empirical tests of a large number of combinations of the salt, complexing system and the solvent were carried out. The results set the experimental roadmap for assembling the metal LS and optimizing it for a given target. Application of the experimental roadmap yielded a “neutrino” grade Yb-LS and proved its general applicability by the production of a high quality In-LS.

It has been observed that organic carboxylates offer a broad choice for the organic salt. The present experimental roadmap sets the criteria for the carboxylic acid: (a) it must be insoluble in water (ruling out those with <5 C atoms); and (b) have a structure with groups that offer steric hindrance against aggregation/polymerization; and (c) is the lightest carboxylate consistent with (a) and (b). Among the few carboxylic acids that fit (a) through (c), the empirical best case was observed to be isovaleric acid, thus, In isovalerate In(IV)₃ was the organic salt of choice.

The complexing system needed two compounds—each for complexing the In(IV)₃—selected in consideration of criteria (a) through (c) hereinabove. For an acid complexing agent, trimethylacetic acid (TMAA) provided a good steric match to the InIV₃ but was observed to not have enough complexation. Also, the free proton in the acid created light quenching. The amount of acid was reduced and a neutral complexer, tributylphosphine oxide (“TBPO”), was added. By fine tuning the additives, the final formulation was reached: In(IV)₃[0.25TBPO,0.1-0.15 TMAA] (molar equivalents in the square brackets).

Referring to FIG. 6, the experimental results for the new In-LS with two solvents, pseudocumene (PC) and 1-methylnaphthalene (MN) are shown. The same criteria lead also to eminent suitability for other purposes in the present invention detailed herein. The scintillation yield relative to a LS standard, S/[S₀=1.2×10⁴(hv)/MeV], is plotted vs. the In loading. Compared to the previous best results, also shown, the new In-LS shows S values up to 3-5 times higher and the useful (i.e. S>50%) range of In-loading extended from <1% to 13-16%. In further experiments of the optical transmission, a preliminary value of the 1/e transmission length of 9% In-LS(PC) was determined to be about 2 m.

Regarding neutron activation, In has high neutron activation cross sections for surface activation of ¹¹⁴In (τ=70d) and in-line, underground ¹¹⁶In (80 min) with only high energy photons (˜1.3 to 2.8 MeV). At sea level, the saturation activity of ¹¹⁴In is 0.5 decays/s/4t In with ˜1% y branching that could contribute a small P(In). In-line production of ¹¹⁶In is higher, ˜150 decays/s/4t In.

In another series of experiments, the following procedure was performed for preparing 0.1 to 1 liter size samples. This procedure was repeated about 50 times at least with a combination of solvents, such as pseudocumene, 1,2,4 tri-methylbenzene, or 1-methylnaphthalene, for example, and initial inorganic compound of a metal, such as a chloride or nitrate, for example. Before mixing the solvent, the proportions used in the procedure were equivalents to about one (1) mole of Yb in the carboxylate sample. The following corresponds with the experimental procedure employed:

1) Preparing one mole of MCl3 or M(NO₃)₃ solution in distilled H₂O;

2) Neutralizing 4.5 equivalents of IVA (excess by 1.5 equiv.) by 4.5 moles of concentrated ammonium hydroxide, adding excess water after neutralization has been completed;

3) Adding organic phase (x equivalents of TBPO, y of TMAA, pseudocumene or 1 methylnaphthalene for the heaviest loading, typically between 10% to 15%, to support fluorescence in liquid scintillator applications, where conventional fluorescent dyes are employed);

4) Adding salt solution of step (1) to step (3) while stirring, to allow the isovalerate to form and immediately dissolve into the organic phase;

5) Gravimetrically separating the organic phase from the water phase; and

6) Drying the organic MIV₃[TBPO:TMAA] phrase by filtering through Na₂SO₄.

From the hereinabove steps, the components employed in the present method include a solvent into which the metal ions may be solvated or loaded. This may be a known solvent having desirable properties associated with a particular application of the present invention. For example, the solvent may have relatively high light conversion properties, and/or inexpensive. Common solvents include, for example, pseudocumene, 1,2,4 tri-methyl benzene or 1 methylnaphthalene.

Another component employed includes an organic salt of the metal to be loaded. The molecular weight of the salt should be as small as possible. In selecting the smallest molecular weight for the salt, the “baggage” of the metal carrying salt in the solvent should be reduced.

Furthermore, a complexing agent may also be used in the present method. The complexing agent may be an additive for certain large scale, liquid scintillator applications. In certain proportions that “complex” the metal, i.e. surround the metal organic salt in such a way that it: (i) inhibits aggregation/polymerization with other metal organic molecules that causes viscosity, haze, gelling etc; (ii) minimizes trapping of the initial energy from reaching the LS solvent and creating light; and (iii) promotes chemical stability (e.g., precipitation of the salt, as well as other instabilities that can result in (i) and (ii)). The complexing agent may comprise trialkyl phosphine oxide or tri-butyl phosphine oxide, for example.

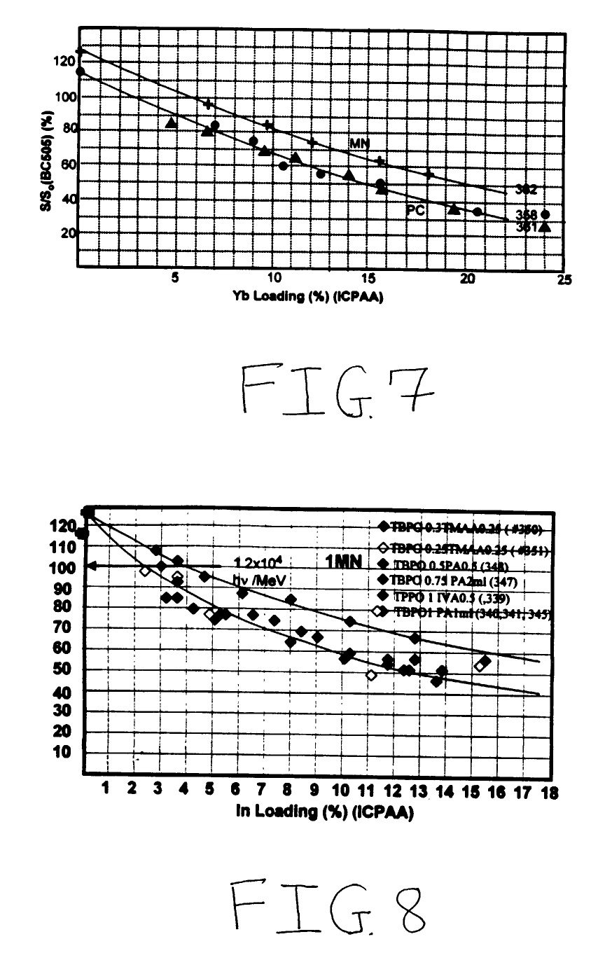

Referring to FIGS. 7 and 8, the results for Yb and In loaded LS obtained by the above experimental procedure for the two solvents PC and MN are illustrated. The results are for the scintillation efficiency relative to a standard LS calibrated for 12000 photons/MeV energy. The results refer to the composition fine tuned with different amounts of the complexing part (TBPO and TMAA). In the In case, these small differences make a non-negligible effect on the scintillation output S. The In data also compares the present results to the previous best results.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. It is therefore contemplated that the appended claims will cover any such modifications or embodiments as fall within the true scope of the invention.

1. An apparatus for detecting energetic radiation from a source, the apparatus comprising:
at least one liquid scintillator for emitting at least one optical signal in response to the energetic radiation, the at least one liquid scintillator comprising a highly metal loaded solution; and
at least one photodetector for detecting the at least one optical signal.

2. The apparatus of claim 1, wherein the at least one liquid scintillator has an energetic radiation sensitivity of at least 50 keV.

3. The apparatus of claim 1, wherein the at least one liquid scintillator has a quenching loss of less than about 25% in emitting the at least one optical signal.

4. The apparatus of claim 1, wherein the optical signal has a power corresponding with an intensity of the energetic radiation.

5. The apparatus of claim 4, wherein the energetic radiation comprises at least one of gamma-rays, x-rays and neutrons.

6. The apparatus of claim 1, further comprising a corrosion resistant vessel for containing the at least one liquid scintillator.

7. The apparatus of claim 6, wherein the corrosion resistant vessel is flexible to adjust around the source of the energetic radiation.

8. The apparatus of claim 1, wherein the highly metal loaded solution comprises an organic solution having at least 10% metal ions by weight solvated therein, the metal ions comprising at least one of Ce, Pr, Nd, Pm, Sm, Eu, Th, Dy, Ho, Er, Tm, Lu, In, Gd, Pb and Yb.

9. The apparatus of claim 1, wherein the source of the energetic radiation comprises at least one of a nuclear power plant, fissionable material, contraband, nuclear weapons, and a radio-pharmaceutical.

10. A radiation detector for detecting at least gamma-rays from a source, the detector comprising:
at least one liquid scintillator for emitting at least one optical signal in response to the gamma rays, the at least one liquid scintillator comprising a highly metal loaded solution stored within a corrosion resistant vessel; and
at least one photodetector for detecting the at least one optical signal.

11. The radiation detector of claim 10, wherein the at least one liquid scintillator has an energetic radiation sensitivity of at least 50 keV, a quenching loss of less than about 25% in emitting the at least one optical signal.

12. The radiation detector of claim 10, wherein the source is a patient having ingested a radio-pharmaceutical, and the vessel at least partially surrounds the patient.

13. The radiation detector of claim 12, further comprising means for displaying at least a two-dimensional image of the patient in response to the at least one optical signal detected by the at least one photodetector.

14. The radiation detector of claim 10, wherein the source comprises radioactive contraband, and the vessel follows along a pathway for detecting the transport of the radioactive contraband.

15. The radiation detector of claim 10, wherein the highly metal loaded solution comprises an organic solution having at least 10% metal ions by weight solvated therein, the metal ions comprising at least one of Pb and Yb.

16. A radiation detector for detecting neutrons emitted from a source, the detector comprising:
at least one liquid scintillator for emitting at least one optical signal in response to the emitted neutrons, the at least one liquid scintillator comprising a highly metal loaded solution stored within a corrosion resistant vessel; and
at least one photodetector for detecting the at least one optical signal.

17. The radiation detector of claim 16, wherein the at least one liquid scintillator has an energetic radiation sensitivity of at least 50 keV, a quenching loss of less than about 25% in emitting the at least one optical signal.

18. The radiation detector of claim 16, wherein the source is at least one of fissionable material and a nuclear power plant.

19. The radiation detector of claim 16, wherein the vessel follows along a pathway for detecting the transport of the fissionable material.

20. The radiation detector of claim 16, wherein the highly metal loaded solution comprises an organic solution having at least 10% metal ions by weight solvated therein, the metal ions comprising at least one of B, Gd, Yb and In.
